(19) United States
(12) Patent Application Publication
(10) Pub. No.: US 2014/0313708 A1
(43) Pub. Date: Oct. 23, 2014

(54) LIGHTING APPARATUS AND METHOD FOR SURFACE LIGHTING USING LEDS

(71) Applicant: Yihao Cheng, Ottawa (CA)

(72) Inventor: Yihao Cheng, Ottawa (CA)

(21) Appl. No.: 14/259,140

(22) Filed: Apr. 22, 2014

Related U.S. Application Data
(60) Provisional application No. 61/814,848, filed on Apr. 23, 2013.

(51) Int. Cl. F21V 21/30; F21V 21/096; F21V 21/088; F21K 99/00

(52) U.S. Cl. CPC F21V 21/30; F21K 9/30; F21V 21/096; F21V 21/088
USPC 362/191; 362/382; 362/311.02; 362/296.01; 362/427; 362/398; 362/396

(57) ABSTRACT

A lighting apparatus and method is disclosed for illuminating a surface using solid-state light emitting diodes (LEDs). The lighting apparatus consists of a plurality of LEDs arranged in an array form, a base for mounting the LEDs, an electrical power supply, and a fixing means for attaching said lighting apparatus to a surface to provide an upward lighting. In some embodiments disclosed in the invention, the base has a shaped surface. In other embodiments, a lensing means is provided. In some embodiments, the LEDs are mounted at an angle. According to the present invention, a method for providing an upward lighting to a surface using LEDs is provided, wherein the lighting apparatus is attached near the bottom of the surface to be illuminated and the angle between the plane of said surface and the center of the light beam from the LEDs is less than 45 degrees.

### CROSS-REFERENCE TO RELATED APPLICATIONS

This application claims priority of U.S. Provisional Patent Application No. 61/814,848 filed on Apr. 23, 2013, entitled “Lighting Apparatus and Method for Surface Lighting using LEDs” which is incorporated herein by reference for all purposes.

### FIELD OF INVENTION

The present invention relates generally to the field of lighting, particularly relating to a light emitting diode (LED) lighting apparatus and method for illuminating a surface, such as sheet music or a music book on a music stand, in an upward fashion.

### BACKGROUND OF THE INVENTION

There are many lighting needs wherein a relatively large area of a surface has to be illuminated, such as lighting for sheet music or a music book placed on a music stand so that the music can be read in a dark environment, or in an art gallery wherein an art display can be illuminated. In the case of lighting sheet music, the prior art solutions for providing lighting are to attach an overhead light to a music stand to provide a downward illumination. Although there are many lights for this purpose, such as the flexible LED lamp described in U.S. Pat. No. 6,808,289 by Reed, all of them are mounted from above and the extrusion of the light source from the music stand obstructs the operation of page flipping during music playing and is also a distraction to the player(s) and audience. Also in some music stand designs or in case of lighting for a piano or keyboard player, it is nearly impossible to attach an overhead light. Therefore, there is an urgent need for a non-overhead mounted surface lighting apparatus which does not extrude from the object to be illuminated, does not obstruct and distract the environment, and also provides an upward lighting.

### SUMMARY OF THE INVENTION

According to the present invention, there is an LED bar light which can be attached to a surface near the bottom, such as the base, shelf of a music stand, to provide an upward lighting wherein the lighting apparatus does not extrude from the surface to be illuminated, eliminating the obstruction and distraction in the prior art. In addition, the present light apparatus and method can be used in any type of music stands and on a piano or keyboard as well as in art galleries.

One embodiment of the present invention consists of a plurality of LEDs arranged in a linear fashion, a base for mounting the LEDs, an electrical power supply, and a fixing means for attaching said lighting apparatus to a surface so that a controlled upward surface illumination is achieved.

The electrical power supply can be a battery pack containing standard batteries and control circuits or a unit contains an AC/DC converter and control driver for use with a standard outlet of an AC source. The power supply may further contain a control circuit for adjusting the lighting intensity. In some embodiments of the present invention, the power supply is integrated into the lighting apparatus.

The LED typically consists of a light-emitting element called the LED die or LED chip, a chip carrier called sub-mount, and electrical leads. More than one LED chip can be packaged into the same sub-mount as well. The LEDs are commercially available from a number of manufacturers, such as Cree, Philips Lumileds, and Osram. In the present invention, the LEDs can be attached to a circuit board in a linear fashion to form an LED assembly. As a result, the distance between LEDs can be easily controlled to provide a relatively uniform lighting. The LED assembly with LEDs attached can then be installed into a metal or non-metal base for attaching to a surface.

In one embodiment of the present invention, the LEDs are arranged generally in a linear fashion, but offset from one other to provide a wider illuminating area.

In some embodiments of the present invention, the illuminating direction, and/or illuminating uniformity of the lighting apparatus are controlled by shaping the base surface around the LEDs area or by further using a lensing element such as a cylindrical lens. Reflective materials such as coatings, paints or tapes can also be applied to the surrounding base surface of the LEDs to increase lighting efficiency.

In one embodiment of the present invention, the mounting base further consists of a tilting mechanism for adjusting the angle of the mounting base and the surface to be illuminated.

In some embodiments of the present invention, the LEDs are mounted in the base at an angle, so that the plane of emitting direction of the LED and the plane of the surface to be illuminated is non parallel.

In some embodiments of the present invention, the fixing means consists of magnets for attaching the lighting apparatus to a magnetic surface, or a mechanical clip for attaching to a non-magnetic surface.

In some embodiments of the present invention, the electrical power supply and the lighting apparatus are designed in such a way that they can be attached to the opposite sides of a plate.

According to the present invention, a method for providing an upward surface lighting using LEDs is provided, wherein a lighting apparatus according to the present invention is attached to a mounting surface which is at bottom of the surface to be illuminated and the plane of the surface to be illuminated and the center of the light beam from the LEDs is less than 45 degree.

Other aspects and advantages of the present invention will become apparent from the following detailed description, taken in conjunction with the accompanying drawings, illustrating by way of examples of the invention.

### BRIEF DESCRIPTION OF THE DRAWINGS

FIG. 1(A) is an illustration of the lighting apparatus according to one of the embodiments of the present invention on a standard music stand; FIG. 1(B) is a cross-section view of said lighting apparatus; FIG. 1(C) illustrates a typical LED; and FIG. 1(D) illustrates the illumination of the LED beam to the back panel of the music stand.

FIG. 2 is cross-section view of the lighting apparatus according to another embodiment of the present invention.

FIG. 3 is an illustration of the arrangement of plurality of LEDs on a circuit board according to one of the embodiments of the present invention.

FIG. 4 is a cross-section view of the lighting apparatus according to another embodiment of the present invention.

FIG. 5 (A) illustrates the lighting apparatus according to one of the embodiment of the present invention and the attachment method to a standard music stand; and FIG. 5(B) is a cross-section view of said lighting apparatus.

FIG. 6 is a cross-section view of another embodiment according to the present invention.

### DETAILED DESCRIPTION OF THE INVENTION

Embodiments of the invention are described herein with reference to schematic illustrations. Embodiments of the invention should not be viewed as limits to the aspect and scope of the present invention.

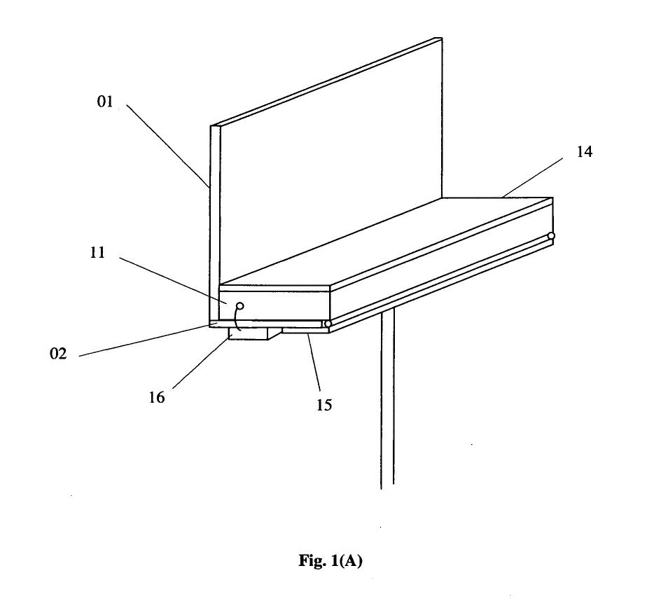

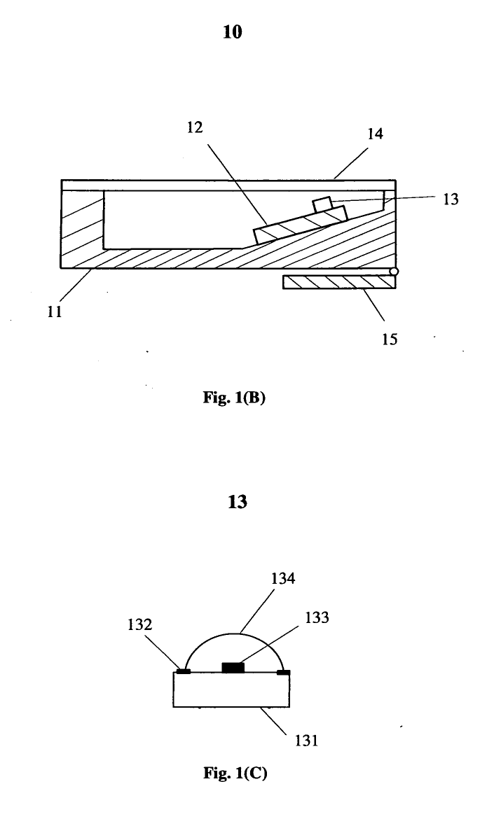

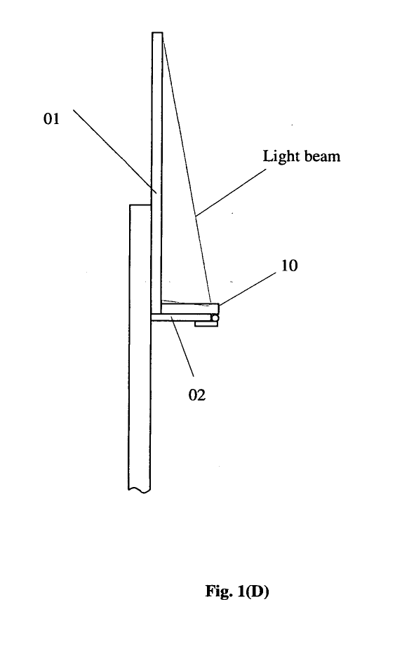

The present invention will now be described with reference to FIG. 1(A) to 1(D). As shown in FIG. 1(A), a lighting apparatus 10 according to the present invention is attached to a standard music stand consisting of a back panel 01 and a shelf 02. The lighting apparatus 10 is attached to the shelf 02 through a spring-loaded clip 15 of the lighting apparatus. A battery power supply 16 is attached to the back side of the same shelf 02 and is electrically connected to the lighting apparatus through electric wires. Now referring to FIG. 1(B), the lighting apparatus consists of a mounting base 11, a circuit board 12 with an array of surface mount LEDs 13 mounted in a linear line and a cover 14. Transparent or translucent materials can be used for the cover 14, depending on desired illuminating effects. The distance between the LEDs is around 1″. The circuit board 12 is mounted at an angle in the base so that the light from the LEDs is effectively directed to the back panel 01. FIG. 1(C) shows an illustration of a commercially available LED 13 that may be used for the present apparatus. The LED 13 typically consists of a light-emitting element called the LED die or LED chip 133, a chip carrier called sub-mount 131, two electrical leads 132, and a lens 134. As illustrated in FIG. 1(D), for a typical music stand with a back panel 01 dimension of 12″ (Height) and 19″ (Width) 10 LEDs with around 1″ separation are used, and LEDs are placed about 1.5″ away from the edge of the base 11. The tilting angle of the circuit board 12 is determined by the divergence of the LED light and the distance between the LEDs and the back panel 01. The lighting apparatus also contains an electric on-off switch and a knob for adjusting the light intensity (both are not shown). The light intensity can be adjusted by changing the pulse width modulation (PWM) of the electric current from the power supply through a control circuit. In the present invention, music sheets or books to be illuminated will be placed on the top cover 14 of the lighting apparatus instead of the music stand shelf 02. However, since the top cover has a flat surface and the same dimension as the shelf 02, there is no obstruction or difference to the page flipping operation. In addition since the light is contained within the range of the back panel 01, there is no disturbance to the surrounding environment.

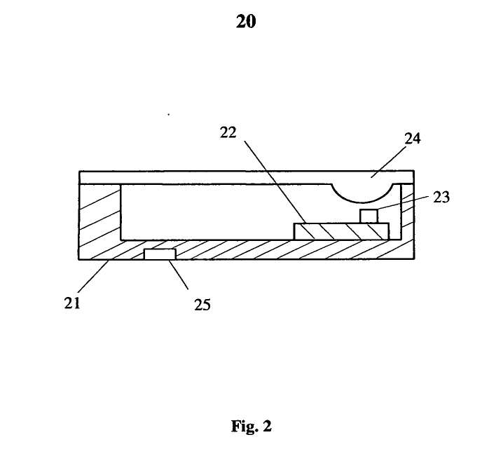

FIG. 2 is a cross-section view of another embodiment of the lighting apparatus 20 according to the present invention, instead of tilting the circuit board 22, a lens is integrated into the cover 24 so that the lighting direction is adjusted by the relative position of the lens and the LEDs. Magnets 25 are used for attaching the present lighting apparatus to a music stand.

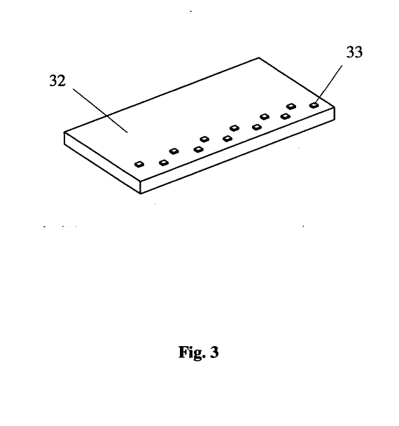

In preferred embodiments, the LEDs are arranged in a linear fashion. However, the LEDs may be arranged in many ways to improve the lighting uniformity or efficiency. One example is shown in FIG. 3 where LEDs are off-set from one another to increase the lighting width.

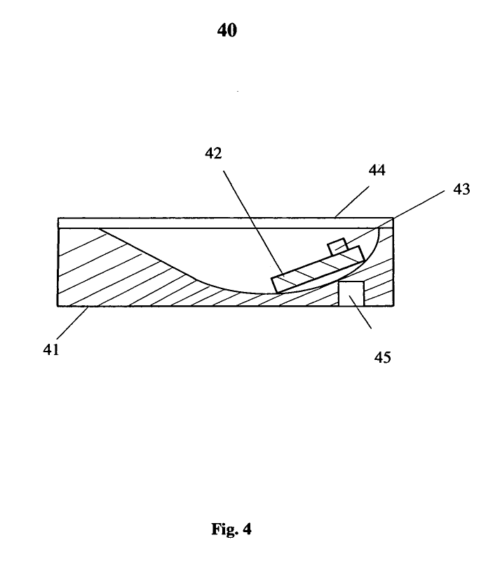

FIG. 4 shows the cross-section view of another embodiment of the present lighting apparatus 40, where lensed LEDs 43 are mounted on a circuit board 42 in a linear fashion and the base 41 has a shaped inner wall to direct the light without the need of any additional lensing element. Magnets 45 are used to attach the lighting apparatus to a music stand. Light from the present apparatus is directed through the translucent cover 44. Reflecting materials can be used on the shaped wall to further increase the lighting efficiency.

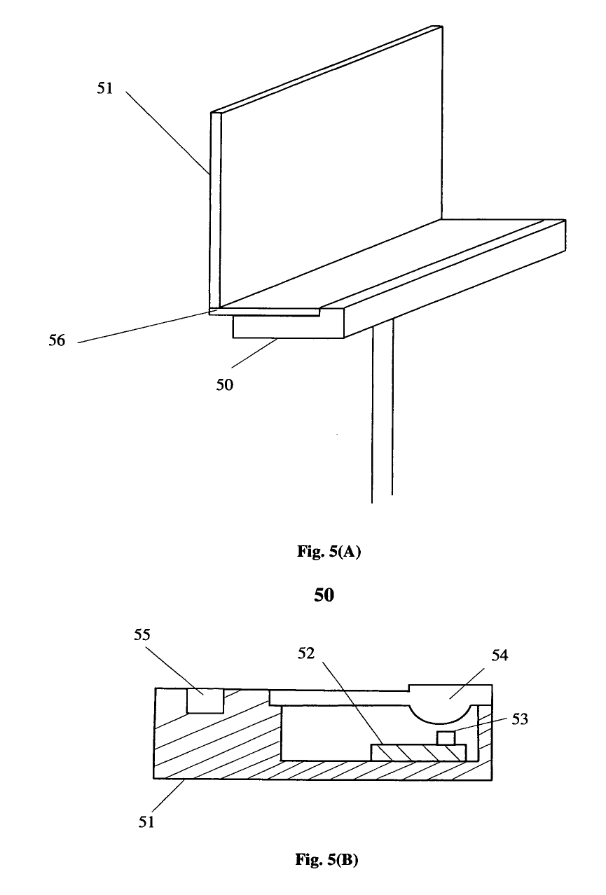

The lighting apparatus according to the present invention can also be attached to the back of the shelf of a music stand, instead of resting on the shelf. One of such arrangement is shown in FIG. 5(A), where the lighting apparatus 50 is attached to the back side of the shelf 56 except for a transparent window. As shown in FIG. 5(B) the lighting apparatus in this embodiment is very similar to the one shown in FIG. 2, the only differences are the transparent cover and the location of the magnets. In this embodiment, magnets are located at top of the lighting apparatus and the transparent window forms a flat surface with the shelf 56 once the light apparatus is attached. In this embodiment, the battery power supply can also be integrated into the apparatus.

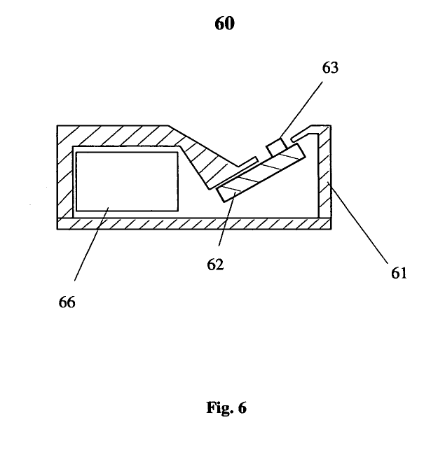

The shape and form factor of the present lighting apparatus is not limited to the regular rectangular, various modifications can be made to further improve the performance. In some of the embodiments the cover 14 shown in FIG. 1(A) can be eliminated. One of the examples is shown in FIG. 6, where the circuit board 62 is inserted from the bottom of the lighting apparatus 60 and mounted at an angle. Light from the LEDs is directed to the back panel of a music stand through an opening in the apparatus. This lighting apparatus can be either top or bottom mounted without changing the lighting characteristics. A battery power supply 66 is integrated into the package.

Although the present invention is illustrated in connection with specific embodiments for instructional purposes, the present invention is not limited thereto. Various combinations, adaptations and modifications may be made without departing from the scope of the invention. Therefore, the spirit and scope of the appended claims should not be limited to the foregoing description.

What is claimed is:

1. A lighting apparatus comprising;
a plurality of LEDs arranged in a linear fashion;
an electrical circuit for supplying electrical power and necessary control to the LEDs
a base for mounting the LEDs and the circuit; and
a fixing means for attaching said lighting apparatus to a surface so that a controlled upward surface illumination is achieved, wherein the direction of illumination from the LEDs is substantially non-parallel to the plane of surface to be illuminated.

2. A lighting apparatus according to claim 1, wherein the LEDs are arranged generally in a linear fashion, but offset from one other to provide a wider illuminating area.

3. A lighting apparatus according to claim 1, wherein the electrical circuit consists of a battery for supplying an electrical power to the LEDs.

4. A lighting apparatus according to claim 1, further comprising a lensing element in front of the LEDs for controlling direction of the illumination and the illumination area.

5. A lighting apparatus according to claim 4, wherein said lensing element is a cylindrical lens.

6. A lighting apparatus according to claim 1, the inner surface of the base is shaped to control the illumination direction and/or illumination uniformity.

7. A lighting apparatus according to claim 6, wherein a reflective material such as coatings, paints or tapes is applied to said inner surface to increase lighting efficiency.

8. A lighting apparatus according to claim 1, wherein the mounting base further consists of a tilting mechanism for adjusting the angle of the mounting base and the surface to be illuminated.

9. A lighting apparatus according to claim 1, wherein the fixing means consists of magnets for attaching the lighting apparatus to a magnetic surface.

10. A lighting apparatus according to claim 1, wherein the fixing means consists of a mechanical clip.

11. A lighting apparatus according to claim 1, wherein the electrical circuit further consists of a adjustable switch to adjust the illumination intensity.

12. A method for providing an upward surface lighting using LEDs is provided, wherein a lighting apparatus according to the present invention is attached to a mounting surface which is at bottom of the surface to be illuminated and the plane of the surface to be illuminated and the center of the light beam from the LEDs is non parallel.
